(19) United States
(12) Patent Application Publication
(10) Pub. No.: US 2026/0259325 A1
(43) Pub. Date: Sep. 3, 2026

(54) INFORMATION PROCESSING DEVICE AND INFORMATION PROCESSING METHOD

(71) Applicant: Sony Group Corporation, Tokyo (JP)

(72) Inventors: Hirotaka TANAKA, Tokyo (JP); Mikio NAKAI, Tokyo (JP)

(73) Assignee: Sony Group Corporation, Tokyo (JP)

(21) Appl. No.: 18/863,649

(22) PCT Filed: Apr. 4, 2023
(86) PCT No.: PCT/JP2023/013989

§ 371 Date: Nov. 7, 2024

(30) Foreign Application Priority Data
May 30, 2022 (JP) 2022-087429

(51) Int. Cl. G01S 17/894; G01S 17/66; G06T 7/20

(52) U.S. Cl. CPC G01S 17/894; G01S 17/66; G06T 7/20; G06T 2207/10028

(57) ABSTRACT

Provided is an information processing device that performs processing related to a SPAD sensor.

The information processing device includes: a determination unit that determines a condition in which a plurality of SPAD sensors are present; and a control unit that, based on a result of the determination by the determination unit, controls switching of an operation mode of the plurality of SPAD sensors. The control unit switches between a synchronous mode in which exposure times of the plurality of SPAD sensors are synchronized and the plurality of SPAD sensors perform sensing simultaneously, and an asynchronous mode in which the plurality of SPAD sensors perform sensing alternately such that the exposure times thereof do not overlap.

### TECHNICAL FIELD

The technique disclosed in the present specification (“present disclosure” hereinafter) mainly relates to an information processing device and an information processing method that perform processing related to sensors which measure distances.

### BACKGROUND ART

A variety of range sensors have been developed, such as Time of Flight (ToF) cameras, Light Detection and Ranging/Laser Imaging Detection and Ranging (LiDAR), and stereo cameras, and such sensors are increasingly being mounted on mobile bodies such as automobiles and robots. None of these devices can be said to be perfect in terms of resolution, measurement range, and noise, and advanced signal processing must therefore be performed on the sensor signals. Recently, layered-structure direct-Time of Flight (d-ToF) type range sensors using Single Photon Avalanche Diode (SPAD) pixels are being developed (d-ToF is a method in which light is emitted from a light source and reflected by a measurement subject, the reflected light is received by a light-receiving element, and the distance is measured based on a difference between the timing of light emission and the timing of light reception). “SPAD” is a pixel structure that uses avalanche multiplication to amplify electrons from a single incident photon, in the manner of an avalanche, and is capable of detecting even weak light.

For example, a rangefinding device has been proposed which includes: a readout circuit that outputs a timing at which a photon is detected by a light-receiving element using a SPAD; a Time to Digital Converter (TDC) that counts time based on the output of the readout circuit; a first histogram generation unit that generates a first histogram based on a count value counted by the TDC at a first time resolution; a computation unit that determines a predetermined bin range of the first histogram; a second histogram generation unit that generates a second histogram having a predetermined bin range based on a count value counted by the TDC at a second time resolution higher than the first time resolution; and a distance computation unit that calculates a distance to a target object based on the second histogram (see PTL 1).

A d-ToF type depth camera using a SPAD sensor has the characteristics of being highly resistant to external light and being capable of taking highly-accurate measurements over long distances, while having a problem in that the resolution is low.

### CITATION LIST

### Patent Literature

[PTL 1] JP 2021-1763A

[PTL 2] JP 2011-253376A

### SUMMARY

### Technical Problem

An object of the present disclosure is to provide an information processing apparatus and an information processing method that perform processing related to a SPAD sensor.

### Solution to Problem

Having been achieved in light of the foregoing problems, a first aspect of the present disclosure is an information processing device including:
a determination unit that determines a condition in which a plurality of SPAD sensors are present; and
a control unit that, based on a result of the determination by the determination unit, controls switching of an operation mode of the plurality of SPAD sensors.

The plurality of SPAD sensors are disposed such that rangefinding points thereof do not overlap and field of view regions thereof at least partially overlap. The control unit switches between a synchronous mode in which exposure times of the plurality of SPAD sensors are synchronized and the plurality of SPAD sensors perform sensing simultaneously, and an asynchronous mode in which the plurality of SPAD sensors perform sensing alternately such that the exposure times thereof do not overlap.

The determination unit determines the condition based on sensor information obtained from a sensor on a device on which the plurality of SPAD sensors are mounted. Specifically, the determination unit determines whether a movement speed of a mobile device on which the plurality of SPAD sensors are mounted is at least a predetermined threshold. The control unit sets the synchronous mode in which exposure times of the plurality of SPAD sensors are synchronized when the movement speed is less than the threshold, and sets the asynchronous mode in which the exposure times of the plurality of SPAD sensors do not overlap when the movement speed is at least the threshold.

Additionally, a second aspect of the present disclosure is an information processing method including:
a determination step of determining a condition in which a plurality of SPAD sensors are present; and
based on a result of the determination in the determination step, a control step of controlling switching of an operation mode of the plurality of SPAD sensors.

### Advantageous Effects of Invention

According to the present disclosure, an information processing device and an information processing method can be provided which perform processing for measuring even long distances at high accuracy and high resolution by integrating a plurality of SPAD sensors.

Note that the effects described in the present specification are merely examples, and the effects provided by the present disclosure are not limited thereto. In addition to the above effects, the present disclosure may have additional effects.

Other objects, features, and advantages of the present disclosure will become clear from detailed descriptions based on embodiments described below and the attached drawings.

### BRIEF DESCRIPTION OF DRAWINGS

FIG. 1 is a diagram illustrating a single SPAD sensor obtaining sensor data constituted by a large number of three-dimensional point clouds.

FIG. 2 is a diagram illustrating a sensing operation that achieves a high resolution by integrating two SPAD sensors.

FIG. 3 is a diagram illustrating an example of fields of view when a first SPAD sensor and a second SPAD sensor are arranged at positions offset from each other.

FIG. 4 is a diagram illustrating exposure timings of the first SPAD sensor and the second SPAD sensor in a high-resolution (synchronous) mode.

FIG. 5 is a diagram illustrating exposure timings of the first SPAD sensor and the second SPAD sensor in a high-response (asynchronous) mode.

FIG. 6 is a diagram illustrating an example of the configuration of a sensing system including a SPAD sensor.

FIG. 7 is a flowchart illustrating a processing sequence for automatically switching an operation mode of a range sensor unit 610 according to a speed.

FIG. 8 is a diagram illustrating an example of an environmental map in which point clouds obtained by the SPAD sensor have been accumulated.

FIG. 9 is a flowchart illustrating a processing sequence for automatically switching the operation mode of the range sensor unit 610 according to a density of point clouds already accumulated.

### DESCRIPTION OF EMBODIMENTS

The present disclosure will be described hereinafter in the following order, with reference to the drawings.
A. Overview
B. Principles of Operation
B-1. Principle of Operation for Achieving High Resolution
B-2. Principle of Operation for Achieving High Response
C. Sensing System Including Plurality of SPAD Sensors
D. Mode Switching Control
D-1. Automatic Switching of Operation Modes According to Speed
D-2. Automatic Switching of Operation Modes According to Point Cloud Density
E. Conclusion

### A. Overview

A SPAD sensor has a pixel array in which pixels using a SPAD as a light-receiving element are arranged two-dimensionally in a row direction and a column direction to form a matrix. A d-ToF type depth camera using a SPAD sensor has the characteristics of being highly resistant to external light and being capable of taking highly-accurate measurements over long distances, while having a problem in that the resolution is low. This is because it is necessary to reduce the pixel pitch in order to achieve a high resolution, but when the pixels are small, the surface area of the photodiodes where photoelectric conversion occurs is also small, which reduces the sensitivity. To compensate for the drop in sensitivity, it is necessary to increase the exposure time (the histogram accumulation time, in the case of a SPAD), resulting in a tradeoff between high resolution and high response.

Accordingly, the present disclosure achieves a high resolution by integrating sensor information from a plurality of sensors, and achieves a high response by causing the plurality of sensors to operate cooperatively. Although the sensor used in the present disclosure is basically a SPAD sensor, a sensor constituted by a pixel array in which light-receiving elements other than SPADs are arranged two-dimensionally may be used as well.

According to the present disclosure, arranging the plurality of sensors such that the fields of view thereof at least partially overlap increases the resolution in the range where the fields of view overlap. For example, in a region where the fields of view of N sensors overlap, the resolution can, according to a simple calculation, be increased by a factor of N. Specifically, when using two SPAD sensors arranged such that the fields of view thereof overlap, the resolution can be doubled in the range where the fields of view overlap.

Meanwhile, an exposure time that is at least a certain length of time is necessary to maintain a minimum level of sensitivity, and thus when a plurality of sensors are operated synchronously, the shortest response time corresponds to the exposure time. In other words, a high response cannot be achieved in a time shorter than the exposure time. Accordingly, in the present disclosure, for example, the plurality of sensors are divided into M groups, and an exposure time T is also divided by M, which results in the exposure operations being performed alternately at timings shifted by T/M on a group-by-group basis such that the exposure operations of the groups do not overlap. As a result, the response speed can be increased by a factor of M compared a case of a single sensor, a case where all the sensors perform exposure operations synchronously, or the like. Specifically, when using two SPAD sensors arranged such that the fields of view thereof overlap, performing exposure operations alternately such that the exposure times of the sensors do not overlap shortens the response time, and the response speed can be doubled compared to the case of a single sensor.

In short, according to the present disclosure, when performing a measurement, such as rangefinding, using a plurality of SPAD sensors, the problem of the resolution and response speed in the SPAD sensors can be solved by adaptively switching between two operation modes depending on the scene, namely a high-resolution mode, in which the sensors are caused to perform exposure operations synchronously to achieve a high resolution, and a high-response mode, in which the response time is shortened by causing the sensors to perform exposure operations asynchronously such that the exposure timings of the sensors do not overlap.

The operation mode may be switched manually, but according to the present disclosure, the operation mode can be switched automatically. For example, when a plurality of SPAD sensors are mounted and used in a mobile device such as an automobile, a robot, a drone, or the like, the operation mode of the sensors is automatically switched according to the conditions, environment, and the like in which the mobile device is moving, which eliminates the need for human operation and contributes to a reduction in the labor required.

A range sensor is mounted on a mobile device in order to detect objects and estimate the self-position of the device. According to the present disclosure, the accuracy of object detection and self-position estimation can be improved by adaptively switching the operation modes, including the high-resolution mode and the high-response mode, of the plurality of sensors mounted on the mobile device.

Specifically, according to the present disclosure, for a region where point clouds have already been successfully obtained at a high density, a plurality of SPAD sensors can capture the point clouds in the high-response mode. On the other hand, for a region where point clouds have been obtained only at a low density, the plurality of SPAD sensors are switched to the high-resolution mode to capture the point clouds selectively. This makes it possible to capture the point clouds in a space evenly and shorten the time required to generate a map in advance.

In addition, according to the present disclosure, highly-accurate map information (an environment map) can be generated by adaptively switching the operation mode of the plurality of SPAD sensors mounted on the mobile device according to the scene (e.g., the conditions, environment, and the like in which the mobile device is moving). As a result, it is less likely that the mobile device will lose its self-position, which makes it possible to prevent unintentional stops, runaways, and the like in the mobile device.

### B. Principles of Operation

Section B will describe principles of operations according to the present disclosure when operating in the high-resolution mode and the high-response mode using a plurality of sensors. For descriptive purposes, all of the plurality of sensors are assumed to be SPAD sensors. “SPAD” is a pixel structure that uses avalanche multiplication to amplify electrons from a single incident photon, in the manner of an avalanche, and is assumed to be used as a d-ToF range sensor. The SPAD sensor itself is already well-known in the industry, and will therefore not be described in detail in the present specification.

### B-1. Principle of Operation for Achieving High Resolution

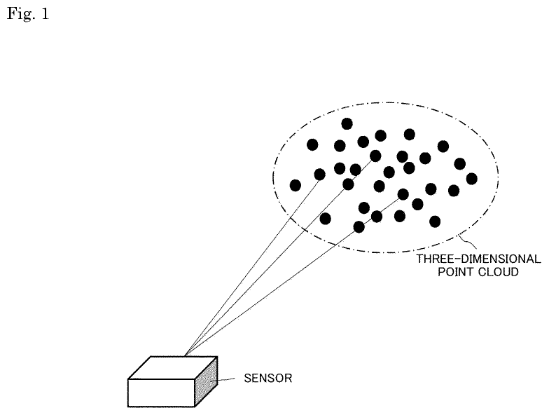

Sensing operations performed using a single SPAD sensor will be described first. FIG. 1 illustrates a single SPAD sensor obtaining sensor data constituted by a large number of three-dimensional point clouds. The SPAD sensor detects a reflected signal or reflected light from an object in a field of view, produced by a laser beam emitted for rangefinding, and outputs a three-dimensional point cloud at each of framerates. In the case of a SPAD sensor, a Vertical Cavity Surface Emitting Laser (VCSEL), which emits a laser beam as a surface light source, is used as the light source, and each of light-receiving elements in the pixel array receives reflected light reflected by the object.

A “three-dimensional point cloud” is a collection of points expressed in three-dimensional coordinates (X, Y, Z), and may be referred to simply as a “point cloud”. By loading the three-dimensional point cloud into a computer for processing, the actual three-dimensional space can be ascertained with ease and expressed to a user in an easily-understandable manner. It is therefore important to capture point cloud data having the required density in an appropriate period and import the data into the computer.

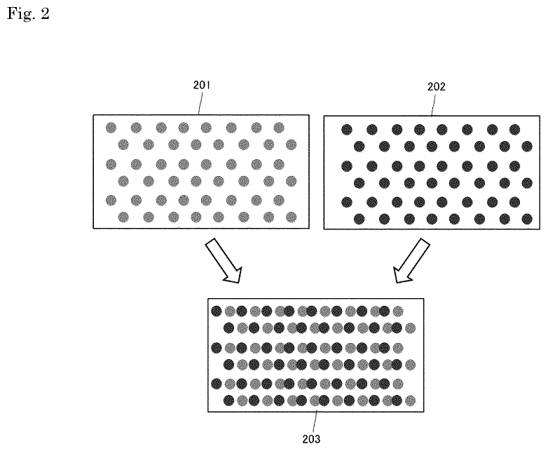

Next, a sensing operation that achieves a high resolution by integrating two SPAD sensors will be described with reference to FIG. 2.

Here, a first SPAD sensor and a second SPAD sensor are disposed (e.g., are mounted on the same mobile device) such that fields of view thereof overlap with each other, and obtain reflected light from the same light source (e.g., a VCSEL laser). Reference signs 201 and 202 in FIG. 2 indicate rangefinding points on respective pixel arrays of the first SPAD sensor and the second SPAD sensor. Distances can also be measured separately from each of the rangefinding points 201 and 202 of the first SPAD sensor and the second SPAD sensor. In contrast, in the present disclosure, by integrating the rangefinding points 201 and 202 of the first SPAD sensor and the second SPAD sensor as indicated by reference sign 203 in FIG. 2, three-dimensional information is obtained at double the density as when the rangefinding is performed separately, which achieves a high resolution.

To achieve a high resolution as illustrated in FIG. 2, it is essential to dispose the first SPAD sensor and the second SPAD sensor with an offset such that the rangefinding points thereof do not overlap, and switch the exposure on and off at the same time. If the first SPAD sensor and the second SPAD sensor are disposed without an offset and the rangefinding points thereof overlap completely, the information from the same rangefinding point is simply obtained in duplicate, which does not achieve a high resolution. In addition, if the exposure timings of the first SPAD sensor and the second SPAD sensor do not match, the range of the same space (or the same object) may not be found (especially when the sensors are mounted on a mobile device), and it therefore may not be possible to integrate the rangefinding points 201 and 202 of the first SPAD sensor and the second SPAD sensor, respectively (or integration may be possible but will not achieve a high resolution).

The direction of the offset between the first SPAD sensor and the second SPAD sensor is not particularly limited, and the sensors may be offset in the horizontal, vertical, or an oblique direction, as long as the rangefinding points of the first SPAD sensor and the second SPAD sensor do not overlap.

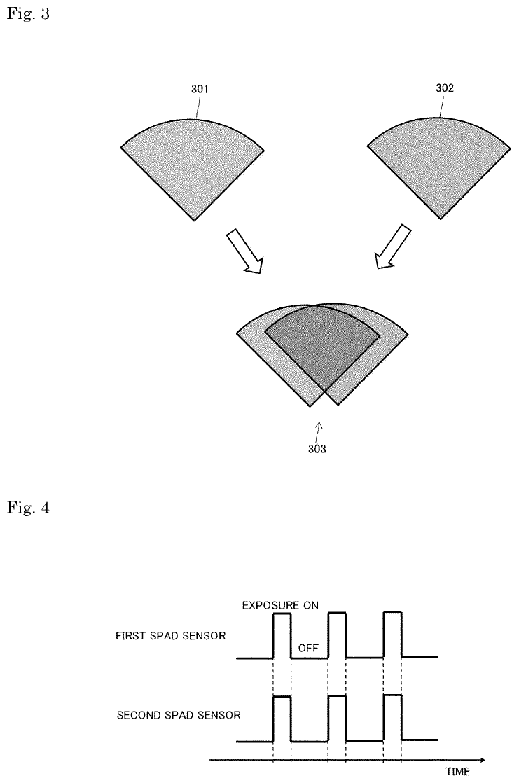

FIG. 3 is a diagram illustrating an example of fields of view when the first SPAD sensor and the second SPAD sensor are arranged at positions offset from each other. Reference signs 301 and 302 in FIG. 3 indicate the fields of view of the first SPAD sensor and the second SPAD sensor, respectively. The fields of view 301 and 302 of the first SPAD sensor and the second SPAD sensor have fan shapes centered on the corresponding sensor itself. When the first SPAD sensor and the second SPAD sensor are disposed at installation positions offset from each other, the fields of view of the first SPAD sensor and the second SPAD sensor are integrated, as indicated by reference sign 303 in FIG. 3. In the region, of the integrated fields of view 303, where the fields of view 301 and 302 of the first SPAD sensor and the second SPAD sensor overlap, the resolution is doubled with respect to the respective resolutions of the first SPAD sensor and the second SPAD sensor, as indicated by reference sign 203 in FIG. 2.

The offset between the first SPAD sensor and the second SPAD sensor may be fixed by using screws to anchor each sensor, or at least one sensor may be mounted on a mobile mechanism, such as a ball bearing, such that the offset amount is variable, i.e., adjustable.

In FIG. 3, the first SPAD sensor and the second SPAD sensor are arranged to be in the same line of sight direction, but even if the line of sight directions thereof do not match, a high resolution is achieved in regions where the fields of view 301 and 302 of the first SPAD sensor and the second SPAD sensor overlap.

To integrate the rangefinding points 201 and 202 of the first SPAD sensor and the second SPAD sensor, which have different viewpoint positions, as illustrated in FIG. 2, it is necessary to convert the rangefinding point as observed from the second SPAD sensor into a rangefinding point as observed from the first SPAD sensor (or, if the second SPAD sensor is taken as the reference, the rangefinding point as observed from the first SPAD sensor into a rangefinding point as observed from the second SPAD sensor). Such processing can be implemented, for example, by projection conversion performed in a stereo camera (see PTL 2, for example).

### B-2. Principle of Operation for Achieving High Response

FIG. 4 is a diagram illustrating exposure timings of the first SPAD sensor and the second SPAD sensor during normal operation (or in a high-resolution mode). The horizontal axis corresponds to the time axis, and the vertical axis represents two values, namely exposure on and exposure off. It is also assumed that the VCSEL laser, which is the light source, is emitting a laser beam in accordance with the timing at which the exposures of both sensors are on.

In the high-resolution mode, the operations are synchronous, with the first SPAD sensor and the second SPAD sensor turning on the exposure simultaneously such that the exposure times are the same as each other, and the sensors therefore sense at the same time. Accordingly, by integrating the sensing results of the first SPAD sensor and the second SPAD sensor, rangefinding information can be obtained at double the density, as indicated by reference sign 203 in FIG. 2, and a high resolution can be achieved. Because the first SPAD sensor and the second SPAD sensor operate in synchronization, the high-resolution mode can also be called a “synchronous mode”.

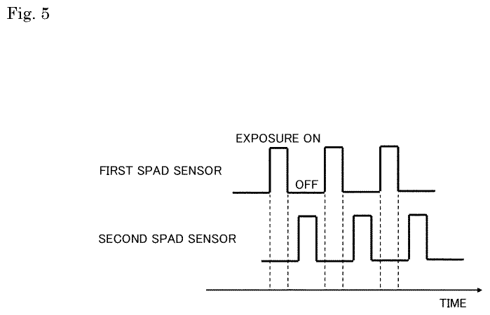

On the other hand, FIG. 5 is a diagram illustrating exposure timings of the first SPAD sensor and the second SPAD sensor in the high-response mode. The horizontal axis corresponds to the time axis, and the vertical axis represents two values, namely exposure on and exposure off (as above). It is also assumed that the VCSEL laser is emitting a laser beam in accordance with the timing at which the exposure is on on a sensor-by-sensor basis.

In the high-response mode, the operations are asynchronous, with the first SPAD sensor and the second SPAD sensor turning on the exposure alternately such that the exposure times do not overlap. Sufficient exposure times are required to compensate for the drop in the sensitivity of the SPAD sensors. In the high-response mode, if the first SPAD sensor and the second SPAD sensor are combined, the exposure timing has double the frequency. However, when focusing on only one of the first SPAD sensor and the second SPAD sensor, an exposure time sufficient for compensating for the drop in sensitivity can be ensured. Additionally, because the first SPAD sensor and the second SPAD sensor perform sensing alternately at each exposure timing, the response speed is double that of the high-resolution mode illustrated in FIG. 4, and a high response can therefore be achieved. However, because only the rangefinding point data of either the first SPAD sensor or the second SPAD sensor can be obtained at any given exposure timing, the resolution is half that of the high-resolution mode. Because the first SPAD sensor and the second SPAD sensor operate out of synchronization, the high-response mode can also be called an “asynchronous mode”.

Accordingly, in a sensing system that performs rangefinding using the first SPAD sensor and the second SPAD sensor, the problem of the resolution and response speed in the SPAD sensors can be solved by adaptively switching between two operation modes depending on the scene, namely the high-resolution mode, in which the first SPAD sensor and the second SPAD sensor are caused to perform exposure operations synchronously to achieve a high resolution, and the high-response mode, in which the response time is shortened by causing the first SPAD sensor and the second SPAD sensor to perform exposure operations asynchronously such that the exposure timings thereof do not overlap.

### C. Sensing System Including Plurality of SPAD Sensors

Section C will describe a sensing system including a plurality of SPAD sensors mounted on a mobile device.

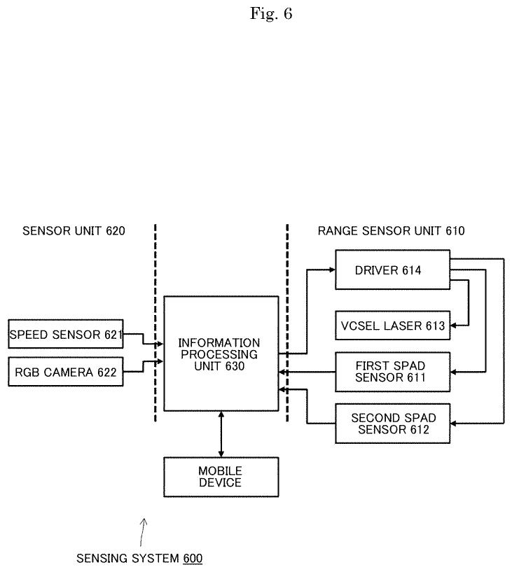

FIG. 6 illustrates an example of the configuration of a sensing system 600 including a plurality of SPAD sensors. The sensing system 600 illustrated here is assumed to be mounted on and used in a mobile device such as an automobile, a robot, a drone, or the like. The sensing system 600 includes three parts, namely a range sensor unit 610 using SPAD sensors, a sensor unit 620 constituted by sensors other than the SPAD sensors mounted on the mobile device, and an information processing unit 630 that processes sensing information from the range sensor unit 610 and the sensor unit 620.

The sensor unit 620 includes, for example, a speed sensor 621 and an RGB camera 622. The speed sensor 621 is broadly classified into an inner field sensor and an outer field sensor. The inner field sensor includes a sensor that measures parameters within the mobile device to serve as the basis of speed information, such as an Inertial Measurement Unit (IMU), a wheel encoder (when the mobile device is a vehicle, a wheeled robot, or the like), or the like. The outer field sensor includes a sensor that can directly measure speed information, such as a LiDAR or a Global Positioning System (GPS) sensor. The speed sensor 621 may be either an inner field sensor or an outer field sensor, or may be a combination thereof. Alternatively, the speed sensor 621 may be omitted, and the speed may be calculated from measurement values measured by the range sensor unit 610. The RGB camera 622 captures an image of the surroundings of the mobile device. For example, a plurality of RGB cameras 622 may be mounted to capture images in a plurality of directions, such as to the front, rear, left, right, and the like of the mobile body.

However, the sensor unit 620 mounted on the mobile device may be configured in any manner, and the present disclosure is not limited to the configuration of the sensor unit 620 illustrated in FIG. 6. The sensor unit 620 may include a ToF sensor, LiDAR, a stereo camera, or the like.

The information processing unit 630 includes, for example, a personal computer (PC), an Electronic Control Unit (ECU), or the like, and processes the sensing information from the range sensor unit 610 and the sensor unit 620 to detect objects in the periphery of the mobile body, estimate the self-position, generate an environment map, and the like. The information processing unit 630 may also perform processing for autonomous driving of an automobile, autonomous operation of a robot, or the like serving as the mobile device, based on the sensing information.

The information processing unit 630 also controls the driving of the range sensor unit 610. Specifically, the information processing unit 630 estimates the conditions, environment, and the like of the mobile device based on the sensing information obtained from the sensor unit 620, and switches the operation mode (i.e., switches between the high-resolution mode and the high-response mode) of the range sensor unit 610, specifies a laser irradiation spot, and the like based on the estimated result.

Note that the information processing unit 630 does not necessarily have to be mounted on the mobile device, and may be wirelessly connected to the range sensor unit 610 and the sensor unit 620 on the mobile device over a wireless LAN such as Wi-Fi, cellular communication such as 5G, or the like.

The range sensor unit 610 includes a first SPAD sensor 611, a second SPAD sensor 612, a VCSEL laser 613, and a driver 614.

Each of the first SPAD sensor 611 and the second SPAD sensor 612 receives reflected light reflected from an object within a corresponding field of view, produced when a laser beam emitted by the VCSEL laser 613 is reflected by the object, and outputs a three-dimensional point cloud at each of framerates. Although depicted abstractly in FIG. 6, the first SPAD sensor 611 and the second SPAD sensor 612 are disposed offset from each other such that the fields of view thereof at least partially overlap and the rangefinding points thereof do not overlap. A mobile mechanism, such as a ball bearing, that can adjust the amount of offset between the first SPAD sensor 611 and the second SPAD sensor 612 may be provided.

The driver 614 specifies the exposure timings and exposure times of the first SPAD sensor 611 and the second SPAD sensor 612, emission operations (measurement frequency) of the VCSEL laser 613, and the like based on an operation mode switching instruction and a laser irradiation spot instruction from the information processing unit 630. The driver 614 also includes a power supply circuit for driving the first SPAD sensor 611 and the second SPAD sensor 612. When a mobile mechanism, such as a ball bearing, capable of adjusting the amount of offset between the first SPAD sensor 611 and the second SPAD sensor 612 is provided, the driver 614 may also drive the mobile mechanism.

Operations by the first SPAD sensor 611 and the second SPAD sensor 612 in the high-resolution mode and the high-response mode are as described in Section B above, and will therefore not be described here. Note also that the number of SPAD sensors provided in the range sensor unit 610 is not limited to two, and may be three or more.

The three-dimensional point cloud data constituted by the rangefinding points obtained by the first SPAD sensor 611 and the second SPAD sensor 612, respectively, is output to the information processing unit 630. The information processing unit 630 performs processing for detecting objects in the periphery of the mobile device, estimating the self-position, generating an environment map, and the like based on the three-dimensional point cloud data collected from the first SPAD sensor 611 and the second SPAD sensor 612. The information processing unit 630 may also control the mobile device (automatic driving of an automobile, autonomous operation of a robot, or the like) based on the sensing information from the range sensor unit 610 and the sensor unit 620.

### D. Mode Switching Control

Section D will describe control for switching the operation mode of the range sensor unit 610 in the sensing system 600 described in Section C above. Although the operation mode may be switched manually, automatically switching the operation mode of the sensors according to the conditions, environment, and the like in which the mobile device is moving eliminates the need for human operation and makes it possible to contribute to a reduction in the labor required.

As described in Section B above, the high-resolution mode is an operation mode that achieves a high resolution by turning the exposures on simultaneously such that the exposure times of the first SPAD sensor 611 and the second SPAD sensor 612 are the same, and integrating the rangefinding points of the first SPAD sensor 611 and the second SPAD sensor 612 (a synchronous mode). The high-response mode is an operation mode that accelerates the framerate of the range sensor unit 610 as a whole by turning the exposures on alternately such that the exposure times of the first SPAD sensor 611 and the second SPAD sensor 612 do not overlap (an asynchronous mode).

The information processing unit 630 estimates a scene encountered by the mobile device based on the sensing information obtained from the sensor unit 620, and instructs the operation mode of the range sensor unit 610 to be switched based on the result of the estimation.

### D-1. Automatic Switching of Operation Modes According to Speed

In a use case where the sensing system 600 is applied to a mobile device capable of moving at a high speed, such as a vehicle, to prevent collisions, accidents, and the like, the movement speed serves as a trigger for switching the operation mode.

When the vehicle is traveling at a low speed, the scene can be assumed to be one in which the vehicle is traveling at around several kilometers per hour, such as in a parking lot, on a narrow lane, or the like, for example. In such a low-speed travel scene, operating the range sensor unit 610 in the high-resolution mode is expected to provide an effect of measuring distances to pedestrians, stationary obstacles, and the like with high accuracy, and reducing the risk of collisions, accidents, and the like.

On the other hand, when the vehicle is traveling at high speed, the scene can be assumed to be one in which the vehicle is traveling steadily at around several tens of kilometers per hour, such as on a highway, a motorway, or the like. In such a high-speed travel scene, the relative speed of objects which are nearly stationary, such as guardrails, trees lining the road, and pedestrians on the sidewalk, increases, whereas in the high-resolution mode, the response speed is slow. This produces a blurring effect, which reduces the quality and reliability of the rangefinding results. In a high-speed travel scene, the response speed is therefore more important than the resolution for avoiding collisions. As such, the range sensor unit 610 switches to the high-response mode and measures the distances to surrounding vehicles, which is expected to provide an effect of reducing the risk of collisions, accidents, and the like among the vehicles.

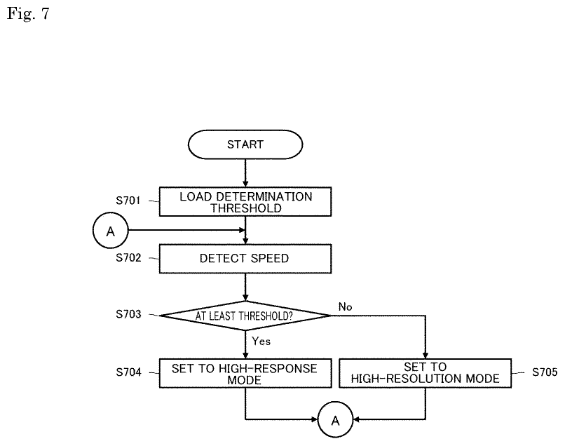

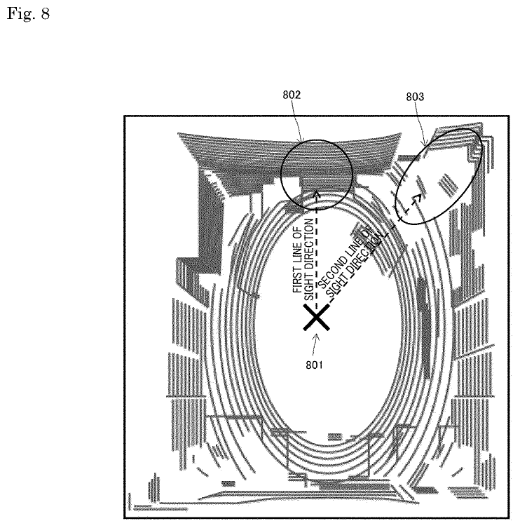

FIG. 7 illustrates, in the form of a flowchart, a processing sequence for automatically switching the operation mode of the range sensor unit 610 according to the speed, in the sensing system 600 applied to a vehicle.

First, the information processing unit 630 loads a speed threshold for determining whether to switch the operation mode (step S701).

Then, while the vehicle is traveling, the information processing unit 630 detects the speed of the vehicle based on the sensing information from the speed sensor 621 (step S702), and checks whether the vehicle speed is at least the determination threshold (step S703).

Here, if the vehicle speed is at least the determination threshold (Yes in step S703), the range sensor unit 610 is set to the high-response mode (step S704), after which the sequence returns to step S702, where the monitoring of the vehicle speed is continued. When the range sensor unit 610 is in the high-resolution mode, the information processing unit 630 instructs the driver 614 to switch to the high-response mode. However, if the range sensor unit 610 is in the high-response mode, the information processing unit 630 maintains the current operation mode.

On the other hand, if the vehicle speed is less than the determination threshold (No in step S703), the range sensor unit 610 is set to the high-resolution mode (step S705), after which the sequence returns to step S702, where the monitoring of the vehicle speed is continued. When the range sensor unit 610 is in the high-response mode, the information processing unit 630 instructs the driver 614 to switch to the high-resolution mode. However, if the range sensor unit 610 is in the high-resolution mode, the information processing unit 630 maintains the current operation mode.

Adaptively and automatically switching the operation mode of the range sensor unit 610 according to the processing sequence illustrated in FIG. 7 while the vehicle is traveling makes it possible to perform object detection adapted to the travel scene of the vehicle, such as traveling in a parking lot, on an ordinary road, on a highway, or the like, and contribute to a reduction in the risk of collisions, accidents, and the like with pedestrians, other vehicles, and the like.

### D-2. Automatic Switching of Operation Modes According to Point Cloud Density

In a use case where the sensing system 600 is applied to an autonomous mobile robot, a drone, or the like that searches a work space such as an indoor space and generates an environment map, the spatial recognition conditions of the robot serve as a trigger for switching the operation mode. More specifically, the “spatial recognition conditions” are a distribution of point clouds in an environment map generated in advance, i.e., point cloud density biases.

FIG. 8 illustrates an example of an environment map in which point clouds obtained using the range sensor unit 610 including a plurality of SPAD sensors have been accumulated. In the figure, parts in gray represent the rangefinding points (point clouds) corresponding to the real world.

FIG. 8 illustrates an environment map obtained by placing an autonomous mobile robot (not shown), on which the range sensor unit 610 is mounted, at a center 801 of a work space, and using the range sensor unit 610 to scan the entire periphery. The range sensor unit 610 is assumed to be mounted on a head part of the autonomous mobile robot and capable of collecting rangefinding points over the entire periphery around the head part by scanning in which the neck is swung to rotate the head part 180 degrees. Of course, instead of swinging the neck, the robot may be operated to collect the rangefinding points over the entire periphery around the body of the robot by driving movement means of the autonomous mobile robot, such as legs or wheels.

The autonomous mobile robot determines the next action (e.g., a route to be traveled next) based on an environment map in which point cloud data obtained by the range sensor unit 610 in a real work space has been accumulated. It is therefore necessary to collect accurate and detailed point cloud data using the range sensor unit 610. However, computing the point cloud data and generating the environment map requires the information processing unit 630 to process a massive amount of data, and attempting to collect the point cloud data aimlessly using the range sensor unit 610 increases the amount of needless data processing. This increases the time required to generate the environment map and leads to an increase in power consumption. Because autonomous mobile robots are basically battery-powered, an increase in power consumption reduces the operation time, making it necessary to recharge or replace the battery and reducing the work efficiency as a result.

Referring again to the environment map illustrated in FIG. 8, the densities of point clouds already obtained are not uniform, and instead vary from region to region. For example, the point cloud density is already relatively high in a field of view region 802 in a first line of sight direction in FIG. 8, but is low in a field of view region 803 in a second line of sight direction. It is not necessary to obtain point clouds excessively in regions where the point cloud density is already high; conversely, if point clouds are not actively obtained in regions where the point cloud density is low, an accurate and detailed environment map cannot be generated.

Accordingly, in the present embodiment, the range sensor unit 610 is operated in the high-response mode in field of view regions where the point cloud density is high (at least a threshold) in the environment map, whereas the range sensor unit 610 is operated in the high-resolution mode to actively obtain point cloud data in field of view regions where the point cloud density is low (less than the threshold). Such a scanning operation makes it possible to generate an accurate and detailed environment map efficiently, and to suppress excessive obtainment of point clouds to contribute to a reduction in the processing load.

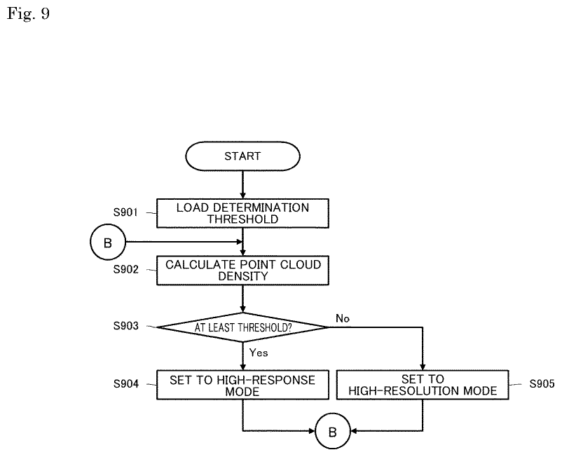

FIG. 9 illustrates, in the form of a flowchart, a processing sequence for automatically switching the operation mode of the range sensor unit 610 according to the density of point clouds already accumulated, when the sensing system 600 applied in an autonomous mobile robot scans the entire periphery and collects rangefinding points.

First, the information processing unit 630 loads a point cloud density threshold for determining whether to switch the operation mode (step S901).

Then, during a scan using the range sensor unit 610, the information processing unit 630 refers to the environment map created up to that point, calculates the point cloud density in the region in the line of sight direction of the range sensor unit 610 (step S902), and checks whether the point cloud density is at least the determination threshold (step S903).

Here, if the point cloud density is at least the determination threshold (Yes in step S903), the range sensor unit 610 is set to the high-response mode (step S904), after which the sequence returns to step S902, where the collection of rangefinding points and the monitoring of the point cloud density is continued. When the range sensor unit 610 is in the high-resolution mode, the information processing unit 630 instructs the driver 614 to switch to the high-response mode. However, if the range sensor unit 610 is in the high-response mode, the information processing unit 630 maintains the current operation mode.

On the other hand, if the point cloud density is less than the determination threshold (No in step S903), the range sensor unit 610 is set to the high-resolution mode (step S905), after which the sequence returns to step S902, where the collection of rangefinding points and the monitoring of the point cloud density is continued. When the range sensor unit 610 is in the high-response mode, the information processing unit 630 instructs the driver 614 to switch to the high-resolution mode. However, if the range sensor unit 610 is in the high-resolution mode, the information processing unit 630 maintains the current operation mode.

Having an autonomous mobile robot implement the scanning operation while adaptively and automatically switching the operation mode of the range sensor unit 610 according to the processing sequence illustrated in FIG. 9 makes it possible to generate an accurate and detailed environment map efficiently, and to suppress excessive obtainment of point clouds to contribute to a reduction in the processing load. In addition, automatically switching the operation mode of the range sensor unit 610 based on a threshold determination for the point cloud density eliminates the need for human operation, i.e., eliminates the need for a human to monitor the operations of the robot, which can also contribute to a reduction in labor.

In the processing sequence described above, the target region for rangefinding in the environment map by the high-resolution mode is automatically determined based on the point cloud density. As a variation thereon, the user may specify the target region as desired in advance. Specifically, the operation mode of the range sensor unit 610 may be switched based on a route plan designed by the user. In this case, in the determination step S902 in the flowchart illustrated in FIG. 9, the operation mode may be switched according to whether the current field of view region of the range sensor unit 610 includes a waypoint on the route plan or includes a movement path.

When the current field of view region of the range sensor unit 610 includes a waypoint on the route plan, or overlaps with a movement path designed in advance, setting the high-resolution mode makes it possible to generate an accurate and detailed environment map along the movement path of the autonomous mobile robot, and contribute to safer movement. On the other hand, when the current field of view region of the range sensor unit 610 does not include a waypoint on the route plan or is off the designed movement path, setting the high-response mode makes it possible to suppress excessive obtainment of point clouds, and contribute to a reduction in the processing load.

Alternatively, if the sensor unit 620 is capable of obtaining rangefinding points, as with a ToF sensor, LiDAR, or a stereo camera, and the environment map is generated in parallel based on the sensing information from the sensor unit 620, the operation mode may be determined based on overlap in the field of view ranges of the range sensor unit 610 and the sensor unit 620. When the field of view region of the range sensor unit 610 does not overlap with the field of view range of the sensor unit 620, the high-resolution mode is set to actively obtain point cloud data. On the other hand, when the field of view region of the range sensor unit 610 overlaps with the field of view range of the sensor unit 620, the high-response mode is set to suppress excessive obtainment of point clouds and reduce the processing load.

Furthermore, as a variation on the operation mode switching based on a route plan, the autonomous mobile robot itself may be permitted to make route changes autonomously while the range sensor unit 610 operates in the high-resolution mode. Specifically, the autonomous mobile robot generates a route plan to supplement locations of low point cloud density by referring to an environment map generated in advance. For example, when an environment map such as that illustrated in FIG. 8 is generated in advance, the autonomous mobile robot changes the route plan from a route that traverses the region 802, which has a sufficiently high point cloud density, to a route that traverses the region 803, which has a low point cloud density. By doing so, the autonomous mobile robot focuses on collecting rangefinding points from regions having a low point cloud density without the need for a human to enter a route plan, which makes it possible to generate an accurate and detailed environment map efficiently.

### E. Conclusion

Finally, Section E summarizes the features of the present disclosure and the effects provided by the present disclosure.
(1) The operation mode of the plurality of SPAD sensors is automatically switched according to the conditions where the plurality of SPAD sensors are present. This makes it possible to adaptively achieve either high-resolution or high-response characteristics superior to the performance of a single SPAD sensor.
(2) When a plurality of SPAD sensors are mounted on a vehicle, the risk of the vehicle being involved in collisions, accidents, or the like can be reduced by automatically switching the operation mode of the plurality of SPAD sensors according to the speed of the vehicle.
(3) When a plurality of SPAD sensors are mounted on an autonomously-moving robot, switching the operation mode of the plurality of SPAD sensors automatically according to the spatial recognition conditions of the robot (the distribution of point clouds in an environment map generated in advance) makes it possible to generate an accurate and detailed environment map efficiently while suppressing excessive obtainment of point clouds and reducing the processing load.
(4) When a plurality of SPAD sensors are mounted on Augmented Reality (AR) glasses or another wearable device, the operation mode of the SPAD sensors can be switched according to the attitude of the part on which a user wears the wearable device (e.g., the head). This is because the purpose of rangefinding information changes according to the attitude of the part on which the device is worn (or the movement of the user's body). For example, if the plurality of SPAD sensors are mounted on AR glasses, the operation mode is automatically switched according to the horizontal angle of the wearer's gaze. The wearer's gaze being at an angle close to vertical is assumed to correspond to measuring the distance to the wearer's feet, which is a relatively short distance. The high-response mode is therefore set to increase the response speed and reduce the risk of collisions with obstacles on the ground. On the other hand, when the likelihood of the wearer's gaze is close to horizontal, the high-resolution mode is set, which makes it possible to improve the recognition rate of distant objects.
(5) When a plurality of SPAD sensors are used in combination with an RGB camera, the operation mode can be automatically switched according to the conditions of the tracking target of the RGB camera. For example, when the tracking target of the RGB camera is a person, an animal, or the like that is moving vigorously, the distance to the tracking target is measured having set the high-response mode, which enables the RGB camera to capture images of the tracking target while tracking fast movements (gestures and the like). Meanwhile, when the tracking target of the RGB camera is far away, the high-resolution mode is set, which enables the RGB camera to capture images without missing tracking targets that are far away.
(6) When a plurality of SPAD sensors are mounted on a flying object such as a drone, the operation mode can be automatically switched according to the altitude of the flight. For example, when flying at low altitudes, fast response times are required to make determinations before falling and colliding with the ground, and thus setting the high-response mode makes it possible to quickly perform operations for avoiding collisions and falls. On the other hand, when flying at high altitudes, the high-resolution mode is set, which makes it possible to increase the 3D scanning resolution of objects (subjects) on the ground.

### INDUSTRIAL APPLICABILITY

The present disclosure has been described thus far in detail with reference to specific embodiments. However, it will be apparent to those skilled in the art that modifications, substitutions, and the like can be made in the embodiments without departing from the essential spirit of the present disclosure.

Although the present specification has mainly described an embodiment applied to a sensor system that integrates two SPAD sensors, the present disclosure can be similarly applied to a sensor system that integrates three or more SPAD sensors. Additionally, although the present specification has mainly described embodiments in which the present disclosure is applied to a sensor system that integrates a plurality of SPAD sensors, the essential spirit of the present disclosure is not limited thereto. The present disclosure can be similarly applied to a sensor system that integrates a plurality of sensors constituted by a pixel array in which light-receiving elements other than SPADs are arranged two-dimensionally.

The present disclosure can be applied to a mobile device such as an automobile, a robot, a drone, or the like, and by switching the operation mode of the sensors according to the conditions, environment, and the like in which the mobile device is moving, the detection of objects, the estimation of a self-position, and the generation of an environment map can be implemented at an advanced level. As a result, it is less likely that the mobile device will lose its self-position, which makes it possible to prevent unintentional stops, runaways, and the like in the mobile device.

The present disclosure can also be applied in AR glasses and other wearable devices. In this case, the operation mode of the SPAD sensors can be switched so as to adapt to the usage of the rangefinding information according to the attitude of the part on which a user wears the wearable device (e.g., the head).

In sum, the present disclosure has been described in the form of examples, and the content of the present specification is not intended to be interpreted as being limiting. The essential spirit of the present disclosure should be determined in consideration of the claims.

The present disclosure can also take on the configurations described below.
(1) An information processing device including:
a determination unit that determines a condition in which a plurality of SPAD sensors are present; and
a control unit that, based on a result of the determination by the determination unit, controls switching of an operation mode of the plurality of SPAD sensors.
(2) The information processing device according to (1), wherein
the plurality of SPAD sensors are disposed such that rangefinding points thereof do not overlap and field of view regions thereof at least partially overlap.
(3) The information processing device according to any one of (1) or (2), wherein
the control unit switches between a synchronous mode in which exposure times of the plurality of SPAD sensors are synchronized and the plurality of SPAD sensors perform sensing simultaneously, and an asynchronous mode in which the plurality of SPAD sensors perform sensing alternately such that the exposure times thereof do not overlap.
(4) The information processing device according to any one of (1) to (3), wherein
the determination unit determines the condition based on sensor information obtained from a sensor on a device on which the plurality of SPAD sensors are mounted.
(5) The information processing device according to any one of (1) to (4), wherein
the determination unit determines whether a movement speed of a mobile device on which the plurality of SPAD sensors are mounted is at least a predetermined threshold, and
the control unit sets a synchronous mode in which exposure times of the plurality of SPAD sensors are synchronized when the movement speed is less than the threshold, and sets an asynchronous mode in which the exposure times of the plurality of SPAD sensors do not overlap when the movement speed is at least the threshold.
(6) The information processing device according to any one of (1) to (4), wherein
when generating an environment map by accumulating point clouds obtained by the plurality of SPAD sensors,
the determination unit determines whether a point cloud density in a field of view region in a line of sight direction of the plurality of SPAD sensors is at least a predetermined threshold, and
the control unit sets a synchronous mode in which the exposure times of the plurality of SPAD sensors are synchronized when the point cloud density is less than the threshold, and sets an asynchronous mode in which the exposure times of the plurality of SPAD sensors do not overlap when the point cloud density is at least the threshold.
(7) The information processing device according to any one of (1) to (4), wherein
the determination unit determines a relationship between a route plan of a mobile robot on which the plurality of SPAD sensors are mounted and a field of view region of the plurality of SPAD sensors, and
the control unit sets a synchronous mode in which exposure times of the plurality of SPAD sensors are synchronized when the field of view region of the plurality of SPAD sensors includes a waypoint on the route plan or overlaps with a movement path, and sets an asynchronous mode in which the exposure times of the plurality of SPAD sensors do not overlap when the field of view region of the plurality of SPAD sensors does not include the waypoint or is off the movement path.
(8) The information processing device according to any one of (1) to (4), wherein
when generating an environment map by accumulating point clouds obtained by the plurality of SPAD sensors and an other sensor in parallel, the determination unit determines a relationship between a field of view region of the plurality of SPAD sensors and a field of view region of the other sensor, and
the control unit sets a synchronous mode in which exposure times of the plurality of SPAD sensors are synchronized when the field of view region of the plurality of SPAD sensors and the field of view region of the other sensor do not overlap, and sets an asynchronous mode in which the exposure times of the plurality of SPAD sensors do not overlap when the field of view region of the plurality of SPAD sensors and the field of view region of the other sensor overlap.
(9) The information processing device according to any one of (1) to (4), wherein
when generating an environment map by accumulating point clouds obtained by the plurality of SPAD sensors mounted on a mobile robot, the control unit generates a route plan for the mobile robot so as to supplement a location where a point cloud density is low in an environment map generated in advance.
(10) The information processing device according to any one of (1) to (4), wherein
the determination unit determines an attitude of a wearable device on which the plurality of SPAD sensors are mounted, and
the control unit sets a synchronous mode in which exposure times of the plurality of SPAD sensors are synchronized, or an asynchronous mode in which the exposure times of the plurality of SPAD sensors do not overlap, based on the attitude of the wearable device.
(11) The information processing device according to (10), wherein the wearable device is AR glasses; and
the control unit sets the synchronous mode in which the exposure times of the plurality of SPAD sensors are synchronized when the AR glasses are oriented at an angle close to horizontal, and sets the asynchronous mode in which the exposure times of the plurality of SPAD sensors do not overlap when the AR glasses are oriented at an angle close to vertical.
(12) The information processing device according to any one of (1) to (4), wherein
when detecting a tracking target of a camera using the plurality of SPAD sensors,
the determination unit determines a state of the tracking target, and the control unit sets a synchronous mode in which exposure times of the plurality of SPAD sensors are synchronized when the tracking target is far away, and sets an asynchronous mode in which the exposure times of the plurality of SPAD sensors do not overlap when the tracking target is moving vigorously.
(13) The information processing device according to any one of (1) to (4), wherein
the determination unit determines whether an altitude of a flying object on which the plurality of SPAD sensors are mounted is at least a predetermined threshold, and
the control unit sets a synchronous mode in which exposure times of the plurality of SPAD sensors are synchronized when the altitude of the flying object is at least the threshold, and sets an asynchronous mode in which the exposure times of the plurality of SPAD sensors do not overlap when the altitude of the flying object is less than the threshold.
(14) An information processing method including:
a determination step of determining a condition in which a plurality of SPAD sensors are present; and
based on a result of the determination in the determination step, a control step of controlling switching of an operation mode of the plurality of SPAD sensors.
(15) A mobile device including:
movement means;
a plurality of SPAD sensors disposed such that rangefinding points thereof do not overlap and field of view regions thereof at least partially overlap;
a determination unit that determines a condition in which the plurality of SPAD sensors are present; and
a control unit that controls switching of an operation mode of the plurality of SPAD sensors based on a result of the determination by the determination unit, and controls movement of the movement means based on a result of rangefinding by the plurality of SPAD sensors.
(16) A wearable device including:
a worn part that is worn on a human body;
a plurality of SPAD sensors disposed such that rangefinding points thereof do not overlap and field of view regions thereof at least partially overlap;
a determination unit that determines a condition in which the plurality of SPAD sensors are present; and
a control unit that, based on a result of the determination by the determination unit, controls switching of an operation mode of the plurality of SPAD sensors.

### REFERENCE SIGNS LIST

600 Sensing system
610 Range sensor unit
611 First SPAD sensor
612 Second SPAD sensor
613 VCSEL laser
614 Driver
620 Sensor unit
621 Speed sensor
622 RGB camera
630 Information processing unit

1. An information processing device comprising:
a determination unit that determines a condition in which a plurality of SPAD sensors are present; and
a control unit that, based on a result of the determination by the determination unit, controls switching of an operation mode of the plurality of SPAD sensors.

2. The information processing device according to claim 1, wherein
the plurality of SPAD sensors are disposed such that rangefinding points thereof do not overlap and field of view regions thereof at least partially overlap.

3. The information processing device according to claim 1, wherein
the control unit switches between a synchronous mode in which exposure times of the plurality of SPAD sensors are synchronized and the plurality of SPAD sensors perform sensing simultaneously, and an asynchronous mode in which the plurality of SPAD sensors perform sensing alternately such that the exposure times thereof do not overlap.

4. The information processing device according to claim 1, wherein
the determination unit determines the condition based on sensor information obtained from a sensor on a device on which the plurality of SPAD sensors are mounted.

5. The information processing device according to claim 1, wherein
the determination unit determines whether a movement speed of a mobile device on which the plurality of SPAD sensors are mounted is at least a predetermined threshold, and
the control unit sets a synchronous mode in which exposure times of the plurality of SPAD sensors are synchronized when the movement speed is less than the threshold, and sets an asynchronous mode in which the exposure times of the plurality of SPAD sensors do not overlap when the movement speed is at least the threshold.

6. The information processing device according to claim 1, wherein when generating an environment map by accumulating point clouds obtained by the plurality of SPAD sensors,
the determination unit determines whether a point cloud density in a field of view region in a line of sight direction of the plurality of SPAD sensors is at least a predetermined threshold, and
the control unit sets a synchronous mode in which exposure times of the plurality of SPAD sensors are synchronized when the point cloud density is less than the threshold, and sets an asynchronous mode in which the exposure times of the plurality of SPAD sensors do not overlap when the point cloud density is at least the threshold.

7. The information processing device according to claim 1, wherein
the determination unit determines a relationship between a route plan of a mobile robot on which the plurality of SPAD sensors are mounted and a field of view region of the plurality of SPAD sensors, and
the control unit sets a synchronous mode in which exposure times of the plurality of SPAD sensors are synchronized when the field of view region of the plurality of SPAD sensors includes a waypoint on the route plan or overlaps with a movement path, and sets an asynchronous mode in which the exposure times of the plurality of SPAD sensors do not overlap when the field of view region of the plurality of SPAD sensors does not include the waypoint or is off the movement path.

8. The information processing device according to claim 1, wherein when generating an environment map by accumulating point clouds obtained by the plurality of SPAD sensors and an other sensor in parallel, the determination unit determines a relationship between a field of view region of the plurality of SPAD sensors and a field of view region of the other sensor, and
the control unit sets a synchronous mode in which exposure times of the plurality of SPAD sensors are synchronized when the field of view region of the plurality of SPAD sensors and the field of view region of the other sensor do not overlap, and sets an asynchronous mode in which the exposure times of the plurality of SPAD sensors do not overlap when the field of view region of the plurality of SPAD sensors and the field of view region of the other sensor overlap.

9. The information processing device according to claim 1, wherein
when generating an environment map by accumulating point clouds obtained by the plurality of SPAD sensors mounted on a mobile robot, the control unit generates a route plan for the mobile robot so as to supplement a location where a point cloud density is low in an environment map generated in advance.

10. The information processing device according to claim 1, wherein
the determination unit determines an attitude of a wearable device on which the plurality of SPAD sensors are mounted, and
the control unit sets a synchronous mode in which exposure times of the plurality of SPAD sensors are synchronized, or an asynchronous mode in which the exposure times of the plurality of SPAD sensors do not overlap, based on the attitude of the wearable device.

11. The information processing device according to claim 10, wherein the wearable device is AR glasses; and
the control unit sets the synchronous mode in which the exposure times of the plurality of SPAD sensors are synchronized when the AR glasses are oriented at an angle close to horizontal, and sets the asynchronous mode in which the exposure times of the plurality of SPAD sensors do not overlap when the AR glasses are oriented at an angle close to vertical.

12. The information processing device according to claim 1, wherein when detecting a tracking target of a camera using the plurality of SPAD sensors,
the determination unit determines a state of the tracking target, and the control unit sets a synchronous mode in which exposure times of the plurality of SPAD sensors are synchronized when the tracking target is far away, and sets an asynchronous mode in which the exposure times of the plurality of SPAD sensors do not overlap when the tracking target is moving vigorously.

13. The information processing device according to claim 1, wherein the determination unit determines whether an altitude of a flying object on which the plurality of SPAD sensors are mounted is at least a predetermined threshold, and
the control unit sets a synchronous mode in which exposure times of the plurality of SPAD sensors are synchronized when the altitude of the flying object is at least the threshold, and sets an asynchronous mode in which the exposure times of the plurality of SPAD sensors do not overlap when the altitude of the flying object is less than the threshold.

14. An information processing method comprising:
a determination step of determining a condition in which a plurality of SPAD sensors are present; and
based on a result of the determination in the determination step, a control step of controlling switching of an operation mode of the plurality of SPAD sensors.
